(19) United States
(12) Patent Application Publication
(10) Pub. No.: US 2018/0282208 A1
(43) Pub. Date: Oct. 4, 2018

(54) METHOD FOR MANUFACTURING OPTICAL FIBER

(71) Applicant: SUMITOMO ELECTRIC INDUSTRIES, LTD., Osaka (JP)

(72) Inventors: Toshihisa SATO, Yokohama-shi (JP); Takashi FUJII, Yokohama-shi (JP)

(73) Assignee: SUMITOMO ELECTRIC INDUSTRIES, LTD., Osaka (JP)

(21) Appl. No.: 15/942,656

(22) Filed: Apr. 2, 2018

(30) Foreign Application Priority Data
Apr. 3, 2017 (JP) 2017-073985

(51) Int. Cl. C03C 25/105; G02B 6/02; C03C 25/326

(52) U.S. Cl. CPC C03C 25/105; C03C 25/326; G02B 6/02395

(57) ABSTRACT

A method for manufacturing an optical fiber comprises a coating step of forming a first layer consisting of a first curable resin composition containing a photopolymerization initiator and a second layer consisting of a second curable resin composition containing another photopolymerization initiator on the glass fiber, a first irradiation step of irradiating UV rays in a first wavelength range from a first UV light source toward the glass fiber, and a second irradiation step of irradiating UV rays in a range shorter in wavelength than the first wavelength range from a second UV light source toward the glass fiber.

### TECHNICAL FIELD

The present invention relates to a method for manufacturing an optical fiber.

This application claims priority based on Japanese Patent Application No. 2017-73985, filed on Apr. 3, 2017, the entire disclosure of which is incorporated herein by reference.

### BACKGROUND

In manufacturing of an optical fiber, a coating resin is cured by using a UV lamp (for example, refer to JP 2014-139131 A and JP 2015-229609 A).

### SUMMARY

It is, however, expensive to use a UV lamp in manufacturing. In contrast, with use of a UV LED instead of a UV lamp, the light with a wavelength required to cure a resin may not be obtained, so that insufficient hardness may be obtained in some cases. There is demand for the realization of a low-cost method for manufacturing an optical fiber that makes it possible to obtain a coating resin having a sufficient hardness, by allowing the photopolymerization of a resin to progress.

The method for manufacturing an optical fiber according to an embodiment of the present invention is a method for manufacturing an optical fiber comprising a glass fiber and a coating resin covering the glass fiber, the method comprising: a coating step of forming a first layer consisting of a first curable resin composition containing a photopolymerization initiator and a second layer consisting of a second curable resin composition containing another photopolymerization initiator on the glass fiber; a first irradiation step of irradiating UV rays in a first wavelength range from a first UV light source toward the glass fiber; and a second irradiation step of irradiating UV rays in a second wavelength range including a range shorter in wavelength than the first wavelength range from a second UV light source toward the glass fiber.

According to the present invention, the photopolymerization of a resin is allowed to proceed, so that a coating resin having a sufficient hardness can be obtained at low cost.

### BRIEF DESCRIPTION OF THE DRAWINGS

FIG. 1 is a cross sectional view showing the structure of an optical fiber according to an embodiment.

FIG. 2 is a flow chart showing the method for manufacturing an optical fiber according to an embodiment.

### DETAILED DESCRIPTION

### Description of Embodiments of the Present Invention

First, the embodiments of the present invention are described below. The method for manufacturing an optical fiber according to an embodiment of the present invention is a method for manufacturing an optical fiber comprising a glass fiber and a coating resin covering the glass fiber, the method comprising: a coating step of forming a first layer consisting of a first curable resin composition containing a photopolymerization initiator and a second layer consisting of a second curable resin composition containing another photopolymerization initiator on the glass fiber; a first irradiation step of irradiating UV rays in a first wavelength range from a first UV light source toward the glass fiber; and a second irradiation step of irradiating UV rays in a second wavelength range including a range shorter in wavelength than the first wavelength range from a second UV light source toward the glass fiber. The term “a second curable resin composition containing another photopolymerization initiator” means that the type or content of the photopolymerization initiator contained in the second curable resin composition is different from the type or content of the photopolymerization initiator contained in the first curable resin composition.

According to the method for manufacturing an optical fiber according to the embodiment described above, depending on the content of the first curable resin composition of the first layer and the content of the second curable resin composition of the second layer, the sequence and the like of use of the first UV light source and the second UV light source that emits UV rays in a range shorter in wavelength than the wavelength range of the first UV ray source are adjusted, so that the first layer and the second layer can be well cured, resulting in the formation of a coating resin having a sufficient hardness. Since two types of UV light sources are used, the cost required for the UV light sources can be reduced by an appropriate selection of the UV light sources.

In an embodiment, the first UV light source can be a UV LED, and the second UV light source can be a UV lamp. Since a UV LED is used together with a UV lamp as UV light sources, the running cost can be reduced in comparison with using a UV lamp only as UV light source. Since a ITV lamp is used together with a UV LED as UV light sources, the initial cost can be reduced in comparison with using a UV LED only as UV light source.

In an embodiment, the first curable resin composition and the second curable resin composition may contain an acylphosphine oxide type initiator. By selecting the first UV light source and the second UV light source such that the acylphosphine oxide type initiator allows a curing reaction to proceed with the UV rays emitted from the first UV light source and the UV rays emitted from the second UV light source, the curing of the first layer and the second layer can be well achieved by using the first UV light source and the second UV light source, respectively. The second curable resin composition may further contain an acetophenone type initiator.

In an embodiment, the first curable resin composition contains an acylphosphine oxide type initiator and the second curable resin composition contains an acetophenone type initiator; the first curable resin composition does not contain the acetophenone type initiator or may contain the acetophenone type initiator at a concentration lower than that of the second curable resin composition. The acylphosphine oxide type initiator may contain 2,4, 6-trimethylbenzoyldiphenylphosphine oxide. The acetophenone type initiator may contain 1-hydroxycyclohexan-1-yl phenyl ketone. When the wavelength range of the UV rays emitted from the first UV light source is included in a wavelength range where the acylphosphine oxide type initiator has a relatively large molecular extinction coefficient, the first layer can be cured with the UV rays emitted from the first UV light source. When the wavelength range of the UV rays emitted from the second UV light source is included in a wavelength range absorbed by the acetophenone type initiator, the second layer can be cured by the UV rays emitted from the second UV light source.

In an embodiment, the second irradiation step is performed after the first irradiation step. After appropriate selection of photopolymerization initiators, the UV irradiation from the first UV light source is performed at first to cure the first layer covered with the second layer in the first irradiation step, and then the second layer can be cured in the subsequent second irradiation step, so that the stress that may remain in the first layer (inner layer of a coating resin) after curing can be sufficiently reduced. Alternatively, the second irradiation step may be performed before the first irradiation step. In that case, although the effect for reducing the stress that may remain in the first layer is small in comparison with the above-mentioned case, an optical fiber having sufficient durability to withstand practical use can be manufactured at low cost depending on uses.

### Details of Embodiment of the Present Invention

A specific example of the method for manufacturing an optical fiber according to an embodiment of the present invention is described as follows with reference to drawings. The present invention, however, is not limited to those examples, and it is intended that the invention is defined by the appended claims and equivalents to the claims and all the changes within the claims are included. In the following description, the same symbols are used for the same elements in the description of drawings, and redundant descriptions are omitted.

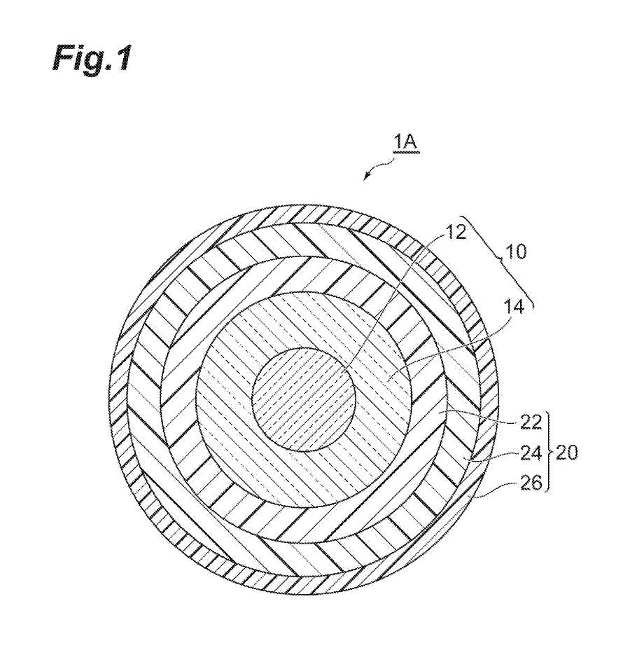

FIG. 1 is a cross sectional view showing the structure of an optical fiber 1A according to an embodiment, illustrating the cross section vertical to the central axis direction (optical axis direction) of the optical fiber 1A. As shown in FIG. 1, the optical fiber 1A of the present embodiment includes a glass fiber 10 as light transmitting member and a coating resin 20. The glass fiber 10 includes a core 12 and a clad 14 covering the core 12. Both of the core and clad are made of silica glass. The coating resin 20 is a UV-curable film covering the clad 14. The coating resin 20 consists of a plurality of layers. At least one layer of the layers in the coating resin 20 is made of cured curable resin composition that contains a photopolymerization initiator. The coating resin 20 includes, for example, a primary resin layer 22 (first layer), a secondary resin layer 24 (second layer), and a colored resin layer 26.

The glass fiber 10 is a member made of glass, consisting of, for example, silica (SiO₂) glass. The glass fiber 10 transmits light introduced into the optical fiber 1A. The core 12 is disposed in, for example, a region including the central axis of the glass fiber 10. The core 12 may be made of pure SiO₂ glass or SiO₂ glass in which GeO₂ and/or fluorine element, etc. are contained. The clad 14 is disposed in a region surrounding the core 12. The clad 14 has a refractive index lower than the refractive index of the core 12. The clad 14 may consist of pure SiO₂ or SiO₂ to which fluorine elements are added.

The primary resin layer 22 in contact with the outer circumferential surface of the clad 14 covers the entire clad 14. The secondary resin layer 24 in contact with the outer circumferential surface of the primary resin layer 22 covers the entire primary resin layer 22. The colored resin layer 26 in contact with the outer circumferential surface of the secondary resin layer 24 covers the entire secondary resin layer 24. In an Example, the primary resin layer 22 may have a layer thickness of 20 μm or more and 50 μm or less, the secondary resin layer 24 may have a layer thickness of, for example, 10 μm or more and 40 μm or less, and the colored resin layer 26 may have a layer thickness of, for example, 3 μm or more and 10 μm or less. The secondary resin layer can be a colored layer to omit the outer colored resin layer 26. The Young's modulus of the primary resin layer 22 may be 0.5 MPa or less, or can be 0.3 MPa or less.

The primary resin layer 22 and the secondary resin layer 24 are formed, for example, by curing a UV-curable resin composition that contains an oligomer, a monomer, and a photopolymerization initiator (reaction initiator).

As the oligomer, a urethane acrylate, an epoxy acrylate, or a mixture system of those can be used. As the urethane acrylate, ones obtained by the reaction of a polyol compound, a polyisocyanate compound, and a hydroxyl group-containing acrylate compound can be used.

As the polyol compound, polytetramethylene glycol, polypropylene glycol, bisphenol A-ethylene oxide adduct diol, and the like can be used. As the polyisocyanate compound, 2,4-tolylene diisocyanate, 2,6-tolylene diisocyanate, isophorone diisocyanate, and the like can be used. As the hydroxyl group-containing acrylate compound, 2-hydroxyethyl acrylate, 2-hydroxybutyl acrylate, 1,6-hexanediol monoacrylate, pentaerythritol triacrylate, 2-hydroxypropyl acrylate, tripropylene glycol diacrylate, and the like can be used.

As the monomer, an N-vinyl monomer having a cyclic structure such as N-vinylpyrrolidone, N-vinylcaprolactam, and acryloyl morpholine can be used. It is preferable to contain these monomers as they improve the curing rate. Other monomers for use include a monofunctional monomer such as isobornyl acrylate, tricyclodecanyl acrylate, benzyl acrylate, dicyclopentanyl acrylate, 2-hydroxyethyl acrylate, nonylphenyl acrylate, phenoxyethyl acrylate, polypropylene glycol monoacrylate; or a polyfunctional monomer such as polyethylene glycol diacrylate, tricyclodecane diyldimethylene diacrylate, and bisphenol A-ethylene oxide adduct diol diacrylate. Note that the acrylate compounds may be respectively corresponding methacrylate compounds.

Examples of the photopolymerization initiator include an acylphosphine oxide type initiator and an acetophenone type initiator. Examples of the acylphosphine oxide type initiator include an acylphosphine oxide compound such as 2,4,6-trimethylbenzoyldiphenylphosphine oxide (registered trade name: LUCIRIN TPO manufactured by BASF), 2,4,4-trimethylpentylphosphine oxide, and 2,4,4-trimethylbenzoyldiphenylphosphinoxide. These acylphosphine oxide type initiators have a wide absorption wavelength range, with an absorption in the visible range and excellent deep curing properties, so that the initiators can be used in the primary resin layer 22 and the secondary resin layer 24.

Examples of the acetophenone type initiator include an acetophenone compound such as 1-hydroxycyclohexan-1-yl phenyl ketone (registered trade name: IRGACURE 184, manufactured by BASF), 2-hydroxy-2-methyl-1-phenyl-propan-1-one (registered trade name: DAROCUR 1173, manufactured by BASF), 2,2-dimethoxy-1, 2-diphenylethan-1-one (registered trade name: IRGACURE 651, manufactured by BASF), 2-methyl-1-(4-methylthiophenyl)-2-morpholinopropan-1-one (registered trade name: IRGACURE 907, manufactured by BASF), 2-benzyl-2-dimethylamino-1-(4-morpholinophenyl)-butanone-1 (registered trade name: IRGACURE 369, manufactured by BASF), 1-hydroxycyclohexyl phenyl ketone, 2,2-dimethoxy-2-phenylacetophenone, and 1-(4-isopropylphenyl)-2-hydroxy-2-methylpropan-1-one. These acetophenone type initiators are hardly subjected to oxygen inhibition, so that the initiators can be used, for example, in the secondary resin layer 24, together with, for example, an acylphosphine oxide type initiator such as LUCIRIN TPO excellent in deep curing properties.

The molecular extinction coefficients (average values) of the photopolymerization initiators for use in manufacturing an optical fiber according to an embodiment are shown in Table 1. LUCIRIN TPO has a larger molecular extinction coefficient shown in Table 1 than IRGACURE 184 in a wavelength range of 350 to 400 nm. In other words, LUCIRIN TPO has a larger absorption of UV rays in the wavelength range of 350 to 400 nm than IRGACURE 184. When a UV LED that emits UV rays in the wavelength range is used, a LUCIRIN TPO-containing UV-curable resin composition has better curability than an IRGACURE 184-containing UV-curable resin composition.

TABLE 1

| | | Molecular extinction |
|---|---|---|
| | | coefficient |
| | Wavelength | (average value) |
| Name | [nm] | [mol⁻¹ · dm³ · cm⁻¹] |
| LUCIRIN TPO | 350-400 | 540 |
| IRGACURE 184 | 350-400 | 200 |

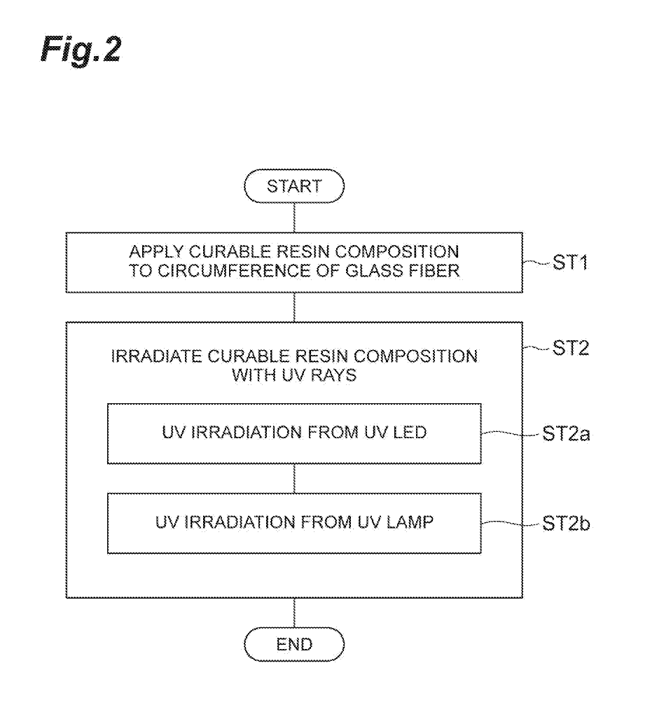

With reference to the flow chart shown in FIG. 2, a method for manufacturing an optical fiber 1A according to an embodiment is described as follows. The method includes a step ST1 (coating step) and a step ST2. The step ST2 is a step of irradiating the glass fiber 10 with UV rays, including a step ST2a (first irradiation step) and a step ST2b (second irradiation step).

In the step ST1, a first curable resin composition containing a photopolymerization initiator is applied to the surface of a glass fiber 10 so as to form a first layer consisting of the first curable resin composition (layer corresponding to a primary resin layer 22 after curing) on the surface of the glass fiber 10, and a second curable resin composition containing another photopolymerization initiator is applied to the surface of the first layer so as to form a second layer consisting of the second curable resin composition (layer corresponding to a secondary resin layer 24 after curing) on the surface of the first layer.

The first curable resin composition may contain an acylphosphine oxide type initiator. The acylphosphine oxide type initiator may contain, for example, LUCIRIN TPO. The second curable resin composition contains an acetophenone type initiator, while the first curable resin composition does not contain the acetophenone type initiator, or may contain the acetophenone type initiator at a concentration lower than that of the second curable resin composition. The acetophenone type initiator may contain, for example, IRGACURE 184. The second curable resin composition may contain an acetophenone type initiator and an acylphosphine oxide type initiator.

Subsequently after the step ST1, in the step ST2, the first curable resin composition of the first layer and the second curable resin composition of the second layer are cured by UV irradiation, so that a primary resin layer 22 is formed from the first layer and a secondary resin layer 24 is formed from the second layer. Through the steps ST1 and ST2 for forming the primary resin layer 22 and the secondary resin layer 24, a coating resin 20 including a colored resin layer 26 is eventually formed.

In the step ST2, a UV LED (first UV light source) and a UV lamp (second UV light source) are sequentially used in UV irradiation as the LTV light sources. Use of a UV lamp only in the UV irradiation has advantages in the initial cost (cost required for UV irradiation equipment), but has disadvantages in the running cost (cost for use), in comparison with use of a UV LED. Use of a UV LED only in the UV irradiation has advantages in the running cost, but has disadvantages in the initial cost, in comparison with use of a UV lamp only. Further, use of a UV LED emitting UV rays in a wavelength range of 350 to 400 nm only, which is on the longer wavelength side of the wavelength for sufficient reaction of a conventional photopolymerization initiator, may result in insufficient curing of a curable resin composition containing such a photopolymerization initiator. In the step ST2, therefore, both of a UV LED and a UV lamp are used together for the UV irradiation to form the coating resin 20.

In the step ST2a, in sequence after the step ST1, the UV rays emitted from a UV LED are irradiated toward the glass fiber 10 from above the second layer. In sequence after the step ST2a, in the step ST2b, the UV rays emitted from a UV lamp are irradiated toward the glass fiber 10 from above the second layer.

The wavelength range of the UV rays emitted from the UV lamp used in the step ST2b (first wavelength range) includes a range shorter in wavelength than the wavelength range of the UV rays emitted from the UV LED used in the step ST2a (second wavelength range). The wavelength range of the UV rays emitted from the UV LED used in the step ST2a is, for example, within 350 to 400 nm, and the wavelength range of the UV rays emitted from the UV lamp used in the step ST2b is, for example, within 200 to 450 nm.

After formation of the primary resin layer 22 and the secondary resin layer 24 by the step ST2, a colored resin layer 26 is formed on the secondary resin layer 24 so as to form a coating resin 20. The coating resin 20 is formed through the steps ST1 to ST2 in the method.

By the method described above, depending on the first curable resin composition contents of the first layer and the second curable resin composition contents of the second layer, the sequence and the like of use of the UV LED and the UV lamp emitting UV rays in the second wavelength including a range shorter in wavelength than the first wavelength range of the UV LED are adjusted to perform good curing of the first layer and the second layer, so that the coating resin 20 having a sufficient hardness can be formed.

In the step ST2a, a UV LED is used, so that the running cost required for the UV light source can be reduced in comparison with using a UV lamp only as the UV light source. In the step ST2b, a UV lamp is used, so that the initial cost required for the UV light source can be reduced in comparison with using a UV LED only as the UV light source.

The UV LED and the UV lamp are selected such that the acylphosphine oxide type initiator contained in the first curable resin composition and the second curable resin composition can absorb the UV rays emitted from the UV LED and the UV lamp, so that curing of the first layer and the second layer using the UV LED and the UV lamp can be well achieved.

The wavelength range of the UV rays emitted from the UV LED used in the step ST2a is included in the wavelength range absorbed by the acylphosphine oxide type initiator which is highly contained in the first layer, so that the first layer can be cured by the irradiation of the UV rays emitted from the UV LED. The wavelength range of the UV rays emitted from the UV lamp used in the step ST2b is included in the wavelength range absorbed by the acetophenone type initiator which is more contained in the second layer than in the first layer (or not contained in the first layer). The second layer is, therefore, more steadily cured than the first layer by the UV rays emitted from the LV lamp. By performing the UV irradiation from the UV LED first in the step ST2a before performing the step ST2b after appropriate selection of photopolymerization initiators, the first layer covered with the second layer is cured faster than the second layer, so that the stress that can remain in the internal layer of the coating resin 20 after curing can be sufficiently reduced.

### EXAMPLES

In the present Example, as the oligomer contained in the first curable resin composition to form the primary resin layer 22, a urethane acrylate was used, and as the photopolymerization initiator, LUCIRIN TPO (1.2 parts by weight) was used. As the oligomer contained in the second curable resin composition to form the secondary resin layer 24, a urethane acrylate was used, and as the photopolymerization initiators, IRGACURE 184 (0.5 parts by weight) and LUCIRIN TPO (0.5 parts by weight) were used.

In the present Example, at a drawing rate of 500 m/min in drawing of an optical fiber, using a UV LED (emission wavelength λ=385 nm) and a UV lamp (metal halide lamp) for the primary resin layer 22 and the secondary resin layer 24, respectively, the following experiment examples 1 to 4 were performed to measure the degree of surface cure (levels A to C) and the low-temperature properties (levels A to C). The degrees of surface cure in the experiment examples 1 to 4 are measured results obtained by an A FR-IR (Attenuated Total Reflecion-InfraRed) method using an FTIR (Fourier Transform InfraRed) spectrometer. In the measurement of the degrees of surface cure, the area ratio of the peaks of absorbance was used. The focused peak of absorbance was at 796 to 818 cm⁻¹ and the reference peak of absorbance was at 753 to 780 cm⁻¹. In the measurement of the degree of surface cure, in particular, the level A represents a case of: Area Ratio<0.2, the level B represents a case of: 0.2≤Area Ratio<0.8, and the level C represents a case of: Area Ratio≥0.8. In the measurement of the low-temperature properties in the experiment examples 1 to 4, the optical fiber in the present Example drawn and rewound under an additional tension load of 1.5 kg was subjected to heat cycles between −60° C. and 25° C. three times. In the measurement of the low-temperature properties, the level A represents a case of: Transmission Loss Difference<0.1 dB/km, the level C represents a case of: Transmission Loss Difference≥0.5 dB/km, and the level B represents a case of: 0.1 dB/km≤Transmission Loss Difference<0.5 dB/km.

### Experiment Example 1

First UV irradiation: UV LED

Second UV irradiation: UV lamp

Degree of surface cure: B

Low-temperature properties: A

### Experiment Example 2

First UV irradiation: UV lamp

Second UV irradiation: UV lamp

Degree of surface cure: A

Low-temperature properties: C

### Experiment Example 3

First UV irradiation: UV lamp

Second UV irradiation: UV LED

Degree of surface cure: B

Low-temperature properties: C

### Experiment Example 4

First UV irradiation: UV LED

Second UV irradiation: UV LED

Degree of surface cure: C

In the experiment examples 1 to 4, with a degree of surface cure of A or B, the durability can be achieved under an environment where the low-temperature properties are required, and with a degree of surface cure of C, use should be avoided under an environment where the low-temperature properties are required. In the comparison between the experiment example 1 and the experiment example 2, although the degree of surface cure in the experiment example 2 was at one rank higher level than in the experiment example 1, the durability in practical use was achieved in both of the experiment examples, and the low-temperature properties were more excellent in the experiment example 1 than in the experiment example 2. Further, a UV lamp only was used in the experiment example 2, while a UV lamp and a UV LED were used together in the experiment example I, so that the better running cost was achieved in the experiment example 1 than in the experiment example 2. It was therefore found that in the UV irradiation to the coating resin 20, the experiment example 1, in which the UV irradiation was performed by using a UV LED at first and then successively by using a UV lamp, was the most advantages in the integrated evaluation on the degree of surface cure, the low-temperature properties, and the costs. In comparison between the experiment example 2 and the experiment example 3, it can be said that the durability in practical use in terms of the degree of surface cure was achieved in both of the experiment examples, and the running cost was better in the experiment example 3 than in the experiment example 2 (conventionally, UV rays have been emitted from a UV lamp only).

According to the experiment examples 1 to 4, with use of a UV LED, the degree of surface cure tends to decrease to some extent in comparison with use of a UV lamp. It is considered that the phenomenon results from the relatively low absorbance of IRGACURE 184 at the emission wavelength of the UV LED of 385 nm. A photopolymerization initiator capable of curing a resin even with a UV LED (photopolymerization initiator that causes cleavages at the wavelength of UV rays emitted from a UV LED, i.e., LUCIRIN TPO in the example described above) is added to the primary resin layer, and a photopolymerization initiator incapable of sufficiently curing a resin with a UV LED (photopolymerization initiator that causes insufficient cleavages at the wavelength of UV rays emitted from a UV LED, i.e., IRGACURE 184 in the example described above) is added to the secondary layer. By emitting the UV rays from a UV LED, the primary resin layer of the curable resin composition applied to the circumference of a light transmitting member is cured first. Subsequently, by emitting the UV rays from a UV lamp, the secondary layer is also sufficiently cured. It is considered that by curing the primary resin layer 22 first, the residual stress in the primary resin layer 22 decreases, so that the low-temperature properties of the optical fiber can be improved.

While the principles of the present invention in a preferred embodiment has been described with reference to drawing, it will be obvious to those skilled in the art that various changes in the arrangement and details of the present invention may be made without departing from the principles. The present invention is not limited to the specific configuration disclosed in the present embodiments. The claims therefore include all the modifications and changes derived from the scope and spirit of the present invention. For example, in the step ST2, the step ST2b may be performed before the step ST2a. The photopolymerization initiator is not limited to the ones described in the embodiments and Example. The embodiments and Example described above can be applied not only to the formation of the primary resin layer 22 and the secondary resin layer 24, but also to the formation of other resin layers such as the colored resin layer 26.

What is claimed is:

1. A method for manufacturing an optical fiber comprising a glass fiber and a coating resin covering the glass fiber, the method comprising:
a coating step of forming on the glass fiber, a first layer consisting of a first curable resin composition containing a photopolymerization initiator and a second layer consisting of a second curable resin composition containing another photopolymerization initiator;
a first irradiation step of irradiating UV rays in a first wavelength range from a first UV light source toward the glass fiber; and
a second irradiation step of irradiating UV rays in a second wavelength range including a range shorter in wavelength than the first wavelength range from a second UV light source toward the glass fiber.

2. The method according to claim 1, wherein the second irradiation step is performed after the first irradiation step.

3. The method according to claim 1, wherein the second irradiation step is performed before the first irradiation step.

4. The method according to claim 2, wherein the first UV light source is a UV LED and the second UV light source is a UV lamp.

5. The method according to claim 3, wherein the first UV light source is a UV LED and the second UV light source is a UV lamp.

6. The method according to claim 1, wherein the second curable resin composition contains an acetophenone type initiator, and the first curable resin composition does not contain the acetophenone type initiator or contains the acetophenone type initiator at a concentration lower than that of the second curable resin composition.

7. The method according to claim 6, wherein the acetophenone type initiator contains 1-hydroxycyclohexan-1-yl phenyl ketone.

8. The method according to claim 1, wherein the first curable resin composition and the second curable resin composition contains an acylphosphine oxide type initiator.

9. The method according to claim 8, wherein the acylphosphine oxide type initiator contains 2,4,6-trimethylbenzoyldiphenylphosphine oxide.

10. The method according to claim 8, wherein the second curable resin composition further contains an acetophenone type initiator.
